(19) United States
(12) Patent Application Publication
(10) Pub. No.: US 2011/0210853 A1
(43) Pub. Date: Sep. 1, 2011

(54) METHOD AND SYSTEM FOR SIMULTANEOUS GUIDELINE EXECUTION

(75) Inventors: William P. Lord, Fishkill, NY (US); Charles Lagor, Ardsley, NY (US); Joseph Rock, Littleton, MA (US)

(73) Assignee: KONINKLIJKE PHILIPS ELECTRONICS N.V., EINDHOVEN (NL)

(21) Appl. No.: 13/125,819

(22) PCT Filed: Oct. 28, 2009
(86) PCT No.: PCT/IB09/54779

§ 371 Date: Apr. 25, 2011

Related U.S. Application Data
(60) Provisional application No. 61/111,923, filed on Nov. 6, 2008.

(51) Int. Cl. G08B 23/00

(52) U.S. Cl. 340/573.1

(57) ABSTRACT

A system and method for retrieving a plurality of sets of recommendations, each of the sets of recommendations corresponding to a condition of a patient, displaying a first one of the sets of recommendations, monitoring data related to each of the plurality of sets of recommendations, determining, based on the monitored data, whether a second one of the sets of recommendations is to be displayed and displaying the second one of the sets of recommendations.

### BACKGROUND

Healthcare providers standardize practices by implementing guidelines for frequently performed medical procedures or other processes. At times, multiple guidelines may simultaneously be active for a single patient, and management of such multiple guidelines, especially where each of the multiple guidelines separately involves different healthcare personnel (e.g., general nurses, general doctors, triage nurses, specialists, anesthesiologists, etc), can prove difficult. There is a long felt need to solve the above-identified problem(s).

### SUMMARY OF THE INVENTION

A method for retrieving a plurality of sets of recommendations, each of the sets of recommendations corresponding to a condition of a patient, displaying a first one of the sets of recommendations, monitoring data related to each of the plurality of sets of recommendations, determining, based on the monitored data, whether a second one of the sets of recommendations is to be displayed and displaying the second one of the sets of recommendations.

A system having a memory storing sets of recommendations, each set of recommendations corresponding to a patient condition, a display and a processor retrieving, from the memory, a plurality of the sets of recommendations, the display displaying a first one of the plurality of the sets of recommendations, the processor monitoring data related to each of the plurality of sets of recommendations and determining, based on the monitored data, whether a second one of the sets of recommendations is to be displayed and instructing the display to display the second one of the sets of recommendations.

### BRIEF DESCRIPTION OF THE DRAWINGS

FIG. 1 shows an exemplary system for coordinating healthcare guidelines according to the present invention.

FIG. 2 shows an exemplary method for coordinating healthcare guidelines according to the present invention.

### DETAILED DESCRIPTION

The exemplary embodiments of the present disclosure may be further understood with reference to the following description and the appended drawings, wherein like elements are referred to with the same reference numerals. The exemplary embodiments describe systems and methods for coordinating the simultaneous performance of multiple clinical guidelines by which healthcare professionals may treat patients with specific conditions.

As used in this disclosure, a “guideline” is a documented set of recommendations for healthcare professionals on how to optimally treat and manage patients with specific diseases and/or conditions. These guidelines are typically not intended to be rigid rules; rather, they are intended to be advice to guide the users thereof. Various efforts have been made to computerize or otherwise automate handling of guidelines, but suffer from flaws including restriction of users to a prescribed order of events, which is often not practical in a clinical setting. For example, the condition of a patient often changes, which cannot be taken into account by a prescribed order of events. The exemplary embodiments disclosed herein overcome these disadvantages and provide further advantages in guideline handling.

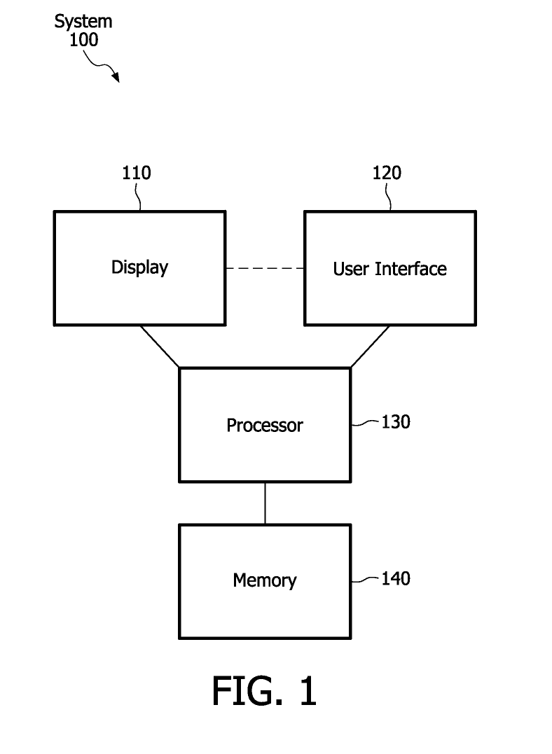

FIG. 1 illustrates an exemplary system 100 for use in coordinating the performance of guidelines, including the tracking of performance of guidelines. The system 100 may be dedicated to this purpose alone, or may also be used to perform other tasks (monitoring patient information or vital signs, etc.). The system 100 may be standalone or may be part of a network spanning one or multiple healthcare provision sites.

The system 100 includes, for example, a display 110 (e.g., a conventional display, a touch-sensitive display, a number of display devices linked together or otherwise, etc.), a user interface 120 (e.g., a touch-sensitive means on a display, a keyboard, a mouse, a touchpad, etc.), a processor 130 capable of coordinating the performance of guidelines in the manner described below and a memory 140 (e.g., data storage such as a hard drive and dynamic or non-volatile memory such as RAM). The system 100 may further optionally include other components such as for example, patient monitoring devices such as a heart rate monitor, a blood pressure monitor, glucometer, etc.

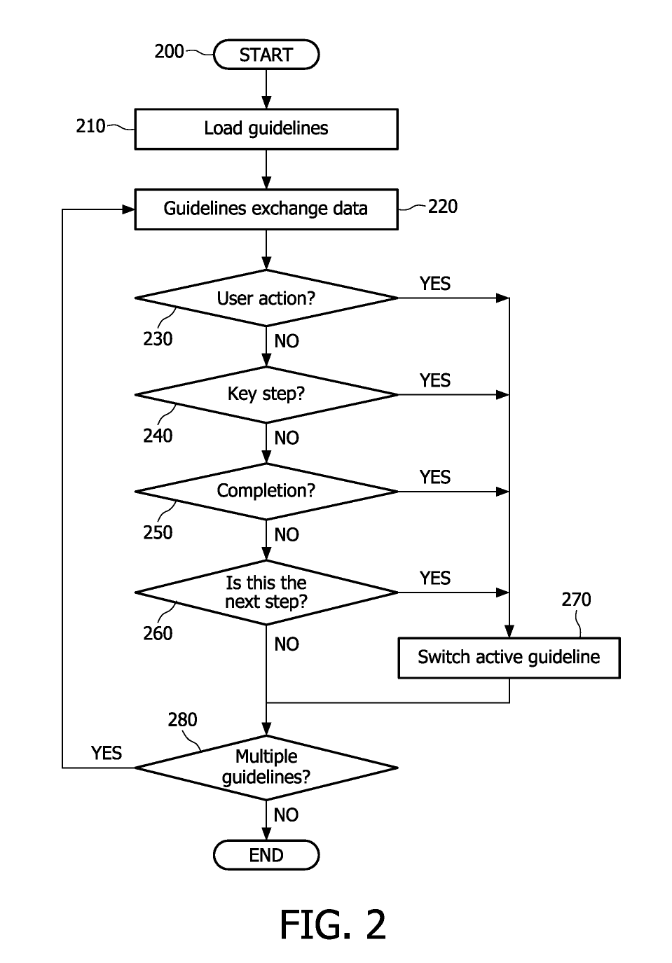

FIG. 2 illustrates an exemplary method 200 for coordinating the performance of simultaneous operation of two or more guidelines. The method 200 may be executed, for example, by the system 100 described above with reference to FIG. 1, or by any other system capable of providing and coordinating instructions as described herein. In step 210, a plurality of guidelines are loaded by the system 100. Guidelines may be stored locally (e.g., in memory 140 of system 100) and retrieved internally, or may be stored and maintained remotely (e.g., at a central location where all guidelines are maintained for a particular hospital, healthcare network, etc.). A guideline typically includes a recommended set of steps to be performed in order to properly treat or resolve the condition. A guideline may be linear (e.g., a set of steps to be performed sequentially), may include steps to be performed in parallel (e.g., simultaneously) with one another, may include branches at which there are two or more steps to be chosen from based on the results of a prior step, etc. Guidelines may be loaded simultaneously or sequentially; if a single guideline is running, the exemplary method 200 commences when a second guideline is loaded and starts running on the system 100.

When step 210 is completed, one of the guidelines (referred to herein as the “active guideline”) is shown to the user on display 110 and therefore has an “active” status; the remaining guideline or guidelines (referred to herein as the “passive guideline(s)) run in the background, but are not displayed to the user, and therefore have a “passive” status. Thus, in this description, the term “active guideline” will be used to describe a guideline that is running and is currently being displayed to a user. The term “passive guideline” will be used to describe a guideline that is running, but is not currently being displayed to a user. As will be described in greater detail below, guidelines may be switched from “active” to “passive” or vice versa based on various events. Furthermore, the term “executing guidelines” will be used to describe all the currently running guidelines, i.e., the combination of the active and passive guidelines. The exemplary method 200 will be described with reference to two simultaneously operating guidelines; however, those of skill in the art will understand that the same principles are equally applicable to three or more simultaneously operating guidelines.

Each guideline typically corresponds to a patient condition, which may be, for example, a disease, an injury, an elective procedure, a test or a group of tests, or any other condition that may have a recommended set of steps associated therewith. Guidelines may be selected via user input (e.g., a user may select from a variety of conditions displayed on the display 110 using the user interface 120) or may be loaded by the system based on input received from input devices (e.g., the system 100 may determine that the patient is having a heart attack based on electrocardiogram information being input into the system 100). Guidelines may be specific to a single patient (e.g., a patient having a heart attack, a patient having a stroke, etc.), but may also apply to a group of patients. For example, a single guideline could monitor a group of patients (e.g., all post operative patients) for signs and symptoms of sepsis and invoke appropriate protocols (for individual patients or for the entire group) when various monitored parameters reach a predetermined threshold, e.g., when monitoring for sepsis among a group of post operative patients, if more than 20% of the patients exhibit a temperature of greater than 101 degrees F., the protocols for handling sepsis may be invoked.

In step 220, the executing guidelines send and receive data between each other. Steps in one guideline may involve receiving data from other guidelines as well as data from other events within the same guideline. For example, the active guideline may include the monitoring of a patient's blood pressure and this information may be input into the system 100 for the monitoring purposes required by the active guideline. However, the passive guideline may also include a blood pressure monitoring functionality. The passive guideline can receive the blood pressure data input into the system 100 for the active guideline and take appropriate steps based on this blood pressure data. Further, guidelines may share events from other parts of an overarching information system (e.g., a Hospital Information System). Examples may include test results performed in other locations such as x-rays, CT scans, electrocardiogram tests, etc. Data sharing may be accomplished by any of the various methods that are known in the art of data sharing.

Steps 230, 240, 250 and 260 of the exemplary method 200 relate to various events that may cause the system 100 to move the active status of the current active guideline to a passive guideline, thereby switching the active guideline in step 270. FIG. 2 illustrates these steps sequentially; however, those of skill in the art will understand that each of the above steps represents a form of monitoring that may be performed by steps that are executed in parallel or in one continuous stream. If none of the events occur, the method continues in step 280.

In step 230, the executing guidelines are monitored for user intervention. A user of system 100 may wish to change the guideline shown on display 110 from the current active guideline to one of the passive guidelines, i.e., an executing guideline that is not currently being displayed. The change may be desired for any reason related to patient treatment, monitoring, testing, etc. The user may initiate such a change via the user interface 120. In step 240, the executing guidelines are monitored to determine whether a passive guideline has reached a key step that requires the attention of a user. Such a key step may include any phase of a guideline that requires user attention. For example, a patient may be the subject of both a ST Elevation Myocardial Infarction (“STEMI”) guideline and a diabetes guideline. Since the STEMI condition is the more critical, it would normally be the foreground and active guideline. However, if the patient's blood sugar drops below a predetermined critical value (e.g., 70), the diabetes guideline could temporarily become the active one. If so, the passive guideline (e.g., the diabetes guideline in the above example) may be switched to an active state. It should be noted that the system 100 may provide the user with a warning (e.g., visible, audio, etc.) that the passive guideline is being switched to active status and the active guideline is being switched to passive status.

In step 250, guidelines are monitored for the completion of key steps. If a key step of the active guideline has been reached, the active guideline may be moved to the background and a formerly passive guideline may become active. For example, a patient with stroke and atrial fibrillation may have active guidelines for both conditions, with the stroke guideline initially in the active state; upon completion of acute stroke management, the stroke guideline becomes passive (thus triggering the monitoring of step 250) and the atrial fibrillation guideline becomes active. In step 260, guidelines are similarly monitored for conditions applying to a group of patients. For example, a group guideline could monitor the number of patients with signs or symptoms of sepsis and could invoke an appropriate individual guideline or guidelines at various numbers.

As described above, if any of the steps 230, 240, 250 or 260 are invoked, the method continues to step 270, at which the display 110 changes from showing the guideline that was previously active to the guideline that was previously passive. Alternately, if none of the steps 230, 240, 250 or 260 are invoked, or following step 270, in step 280 the method determines whether there are multiple guidelines still executing simultaneously. As described above, guidelines relating to different conditions may operate independently from one another and thus one may terminate while one or more other guidelines continue to operate. If multiple guidelines remain in operation, the method returns to step 220 and data exchange continues. However, if fewer than two guidelines remain in operation, the method terminates.

In the above-described exemplary embodiment, the system 100 is described as adapted to display various guidelines, with primacy being given to an active guideline that may be deemed most important for various reasons. In another exemplary embodiment, the information provided by a system (e.g., in this embodiment, a single workstation in a broader health care network) may be specific to the user of the system. In such an embodiment, rather than displaying a full guideline for a disease and/or patient, the user would be provided with only the steps that concerned him/her. For example, for a guideline relating to a CT exam, an x-ray technician's workstation would display only the step of the guideline relating to the performance of the CT scan itself; subsequently, when the scan is completed, a radiologist's workstation would display only the step of the guideline relating to the interpretation of the scan.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

1. A method, comprising:
retrieving a plurality of sets of recommendations, each of the sets of recommendations corresponding to a condition of a patient;
simultaneously executing the plurality of sets of recommendations;
displaying a first one of the sets of recommendations;
monitoring data related to each of the plurality of sets of recommendations;
determining, based on the monitored data, whether a second one of the sets of recommendations is to be displayed; and
displaying the second one of the sets of recommendations.

2. The method of claim 1, wherein the data is a user input.

3. The method of claim 1, wherein the data is an indication of a termination of the first one of the sets of recommendations.

4. The method of claim 1, wherein the data is an indication that the second one of the sets of recommendations is at an instruction having a high importance.

5. The method of claim 1, wherein the first one of the set of recommendations is specific to the patient and the second one of the set of recommendations is general to a group of patients to which the patient belongs.

6. The method of claim 5, wherein the data is from one or more of the group of patients and not from the patient.

7. The method of claim 1, further comprising:
providing a user with a warning relating to modifying the display from the first one of the set of recommendations to the second one of the set of recommendations.

8. The method of claim 7, wherein the warning is one of a visible warning and an audible warning.

9. The method of claim 1, wherein only selected recommendations of the first and second sets of recommendations are displayed corresponding to a predetermined type of health care provider.

10. The method of claim 9, wherein the predetermined type of health care provider is one of a radiologist, a nurse, an x-ray technician, an emergency room physician and a surgeon.

11. The method of claim 1, further comprising:
monitoring further data related to each of the plurality of sets of recommendations;
determining, based on the monitored further data, whether a further one of the sets of recommendations is to be displayed; and
displaying the further one of the sets of recommendations.

12. The method of claim 1, wherein the data is monitored by the first set of recommendations and the second set of recommendations retrieves the data from the first set of recommendations.

13. A system, comprising:
a memory (140) storing sets of recommendations, each set of recommendations corresponding to a patient condition,
a display (110); and
a processor (130) retrieving, from the memory (140), a plurality of the sets of recommendations, the processor simultaneously executing the plurality of sets of recommendations, the display (110) displaying a first one of the plurality of the sets of recommendations, the processor (130) monitoring data related to each of the plurality of sets of recommendations and determining, based on the monitored data, whether a second one of the sets of recommendations is to be displayed and instructing the display (110) to display the second one of the sets of recommendations.

14. The system of claim 13, wherein the data is one of a user input, an indication of a termination of the first one of the sets of recommendations and an indication that the second one of the sets of recommendations is at an instruction having a high importance.

15. The system of claim 13, wherein the first one of the set of recommendations is specific to the patient and the second one of the set of recommendations is general to a group of patients to which the patient belongs.

16. The system of claim 13, wherein the processor (130) receives the data from an external information system.

17. The system of claim 16, wherein the external information system is a hospital information system.

18. The system of claim 13, wherein the processor (130) receives the data from a further device connected to the system.

19. The system of claim 13, wherein the data includes one of a test result and a result of a monitoring process.

20. A computer readable storage medium including a set of instructions executable by a processor, the instructions operable to:
retrieve a plurality of sets of recommendations, each of the sets of recommendations corresponding to a condition of a patient;
execute, simultaneously, the plurality of sets of recommendations;
display a first one of the sets of recommendations;
monitor data related to each of the plurality of sets of recommendations;
determine, based on the monitored data, whether a second one of the sets of recommendations is to be displayed; and
display the second one of the sets of recommendations.
